(19) United States
(12) Patent Application Publication
(10) Pub. No.: US 2012/0060014 A1
(43) Pub. Date: Mar. 8, 2012

(54) ELECTRONIC DEVICE AND METHOD FOR PROTECTING ELECTRONIC KEYS USING THE SAME

(75) Inventors: CHUNG-I LEE, Tu-Cheng (TW); CHIEN-FA YEH, Tu-Cheng (TW); CHIU-HUA LU, Tu-Cheng (TW); CHENG-FENG TSAI, Tu-Cheng (TW); SHAN-CHUAN JENG, Tu-Cheng (TW); YU-FENG CHIEN, Tu-Cheng (TW); TSUNG-HSIN YEN, Tu-Cheng (TW)

(73) Assignee: HON HAI PRECISION INDUSTRY CO., LTD., Tu-Cheng (TW)

(21) Appl. No.: 13/082,408

(22) Filed: Apr. 8, 2011

(30) Foreign Application Priority Data
Sep. 7, 2010 (TW) 99130250

(51) Int. Cl. G06F 12/08

(52) U.S. Cl. 711/216; 711/E12.018

(57) ABSTRACT

A method for protecting electronic keys sets a plurality of hash functions, divides an electronic key into a plurality of key segments, creates a data storage structure for each of the key segments, and calculates a hash address for each of the key segments of the electronic key using each of the hash functions. The method further obtains a plurality of hash addresses of the plurality of key segments corresponding to the plurality of hash functions, stores information of the data storage structure of each key segment in a hash table according to the hash address of the key segment corresponding to one of the hash functions.

### BACKGROUND

1. Technical Field

Embodiments of the present disclosure relates to information security technology, and particularly to an electronic device and method for protecting electronic keys using the electronic device.

2. Description of Related Art

Electronic keys, such as license keys, are used to protect digital data stored in digital disks (e.g, HD DVD). A software player needs to obtain a license key from a third-party authentication center to decode the digital data stored in the digital disks. However, the license key may be obtained illegally using a debug method of the software player. Therefore, a more effective method for protecting electronic keys is desired.

### BRIEF DESCRIPTION OF THE DRAWINGS

FIG. 1 is a block diagram of one embodiment of an electronic device.

FIG. 2 is a block diagram of one embodiment of a key protection system in the electronic device.

FIG. 3 is a flowchart of one embodiment of a method for protecting electronic keys using the electronic device.

FIG. 4 is a schematic diagram of a plurality of key segments divided from an electronic key.

FIG. 5A-5D are schematic diagrams of data storage structures of each of the plurality of key segments shown in FIG. 4.

### DETAILED DESCRIPTION

All of the processes described below may be embodied in, and fully automated via, functional code modules executed by one or more general purpose electronic devices or processors. The code modules may be stored in any type of non-transitory readable medium or other storage device. Some or all of the methods may alternatively be embodied in specialized hardware. Depending on the embodiment, the non-transitory readable medium may be a hard disk drive, a compact disc, a digital video disc, a tape drive or other suitable storage medium.

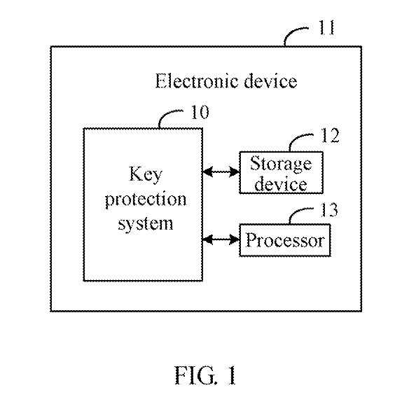

FIG. 1 is a block diagram of one embodiment of an electronic device 11, including a key protection system 10, a storage device 12, and at least one processor 13. The key protection system 10 may be used to protect electronic keys using a plurality of hash functions. In one embodiment, the keys may be license keys or authentication keys. The storage device 12 may be a hard disk to store digital data, such as the electronic keys.

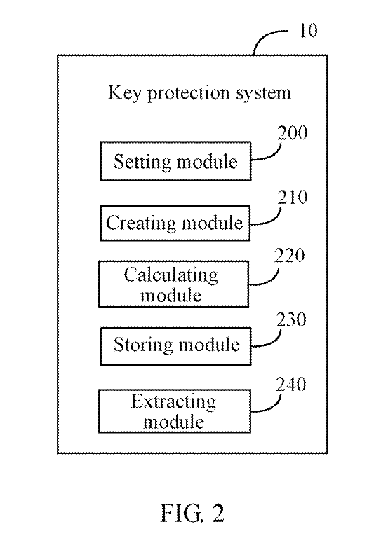

FIG. 2 is a block diagram of one embodiment of the key protection system 10 in the electronic device 11. In one embodiment, the key protection system 10 may include one or more modules, for example, a setting module 200, a creating module 210, a calculating module 220, a storing module 230, and an extracting module 240. The one or more modules 200-240 may comprise computerized code in the form of one or more programs that are stored in the storage device 12 (or memory). The computerized code includes instructions that are executed by the at least one processor 13 to provide functions for the one or more modules 200-240.

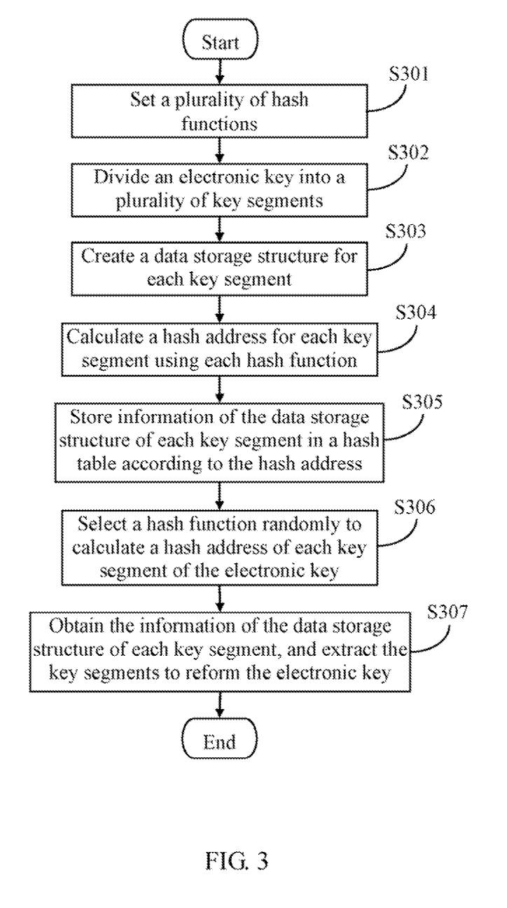

FIG. 3 is a flowchart of one embodiment of a method for protecting electronic keys using the electronic device 11. Depending on the embodiment, additional blocks may be added, others removed, and the ordering of the blocks may be changed.

In block S301, the setting module 200 sets a plurality of hash functions. In one embodiment, the plurality of hash functions may include a first hash function, a second hash function, and a third hash function.

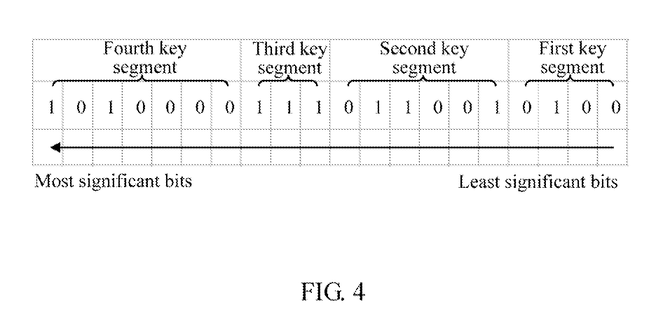

In block S302, the creating module 210 divides an electronic key into a plurality of key segments. As shown in FIG. 4, the electronic key “10100001110110010100” is divided into four key segments, a first key segment “0100,” a second key segment “011001,” a third key segment “111,” and a fourth key segment “1010000.” The first key segment is located in the least significant bits, and the fourth key segment is located in the most significant bits.

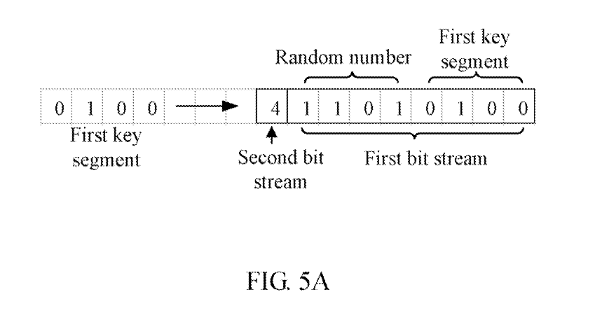

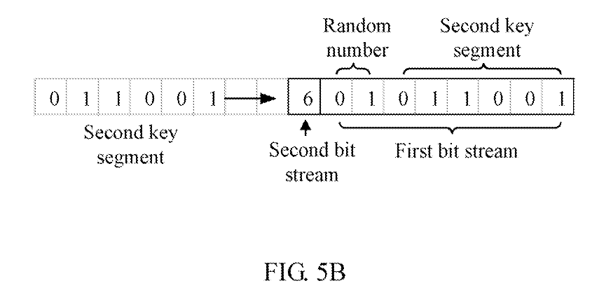

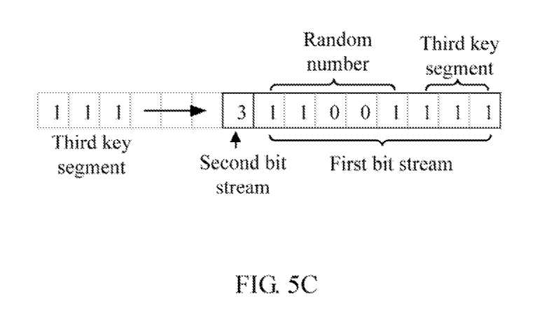

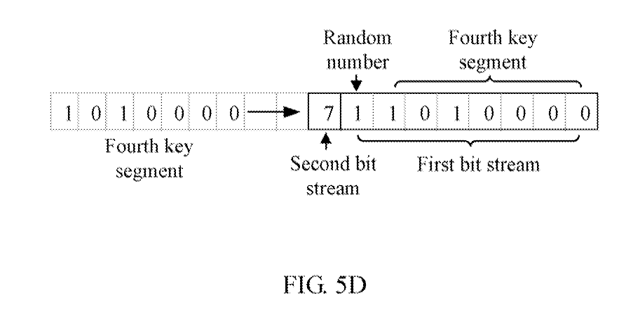

In block S303, the creating module 210 creates a data storage structure for each of the key segments stored in the storage device 12. In one embodiment, the data storage structure is an array or a queue. For example, as shown in FIG. 5A, the data storage structure of the first key segment may include a first bit stream and a second bit stream. The first bit stream includes the first key segment and a plurality of random numbers. The second bit stream records a number of bits of the first key segment stored in the first bit stream. In one embodiment, a length of the first bit stream is unchangeable (e.g., eight bits), the key segment is allocated in the least significant bits of the first bit stream. In the same way, FIG. 5B is an example of the data storage structure of the second key segment, FIG. 5C is an example of the data storage structure of the third key segment, and FIG. 5D is an example of the data storage structure of the fourth key segment.

In block S304, the calculating module 220 calculates a hash address for each of the key segments using each of the hash functions, and obtains a plurality of hash addresses of the key segments corresponding to the hash functions. For example, a hash address of the first key segment is “7” calculated by the first hash function, a hash address of the second key segment is “3” calculated by the first hash function, a hash address of the third key segment is “5” calculated by the first hash function, and a hash address of the fourth key segment is “11” calculated by the first hash function. If a collision (i.e., hash collision) of the hash addresses occurs, the calculating module 220 resolves the collision of the hash addresses using an open addressing method.

In block S305, the storing module 230 stores information of the data storage structure of each of the key segments in a hash table according to the hash address of the key segment corresponding to one of the hash functions. For example, the storing module 230 stores the information of the data storage structure of the first key segment in the hash address “7” of the hash table corresponding to the first hash function, stores the information of the data storage structure of the second key segment in the hash address “3” of the hash table corresponding to the first hash function, and stores the information of the data storage structure of the third key segment in the hash address “5” of the hash table corresponding to the first hash function.

In block S306, if the electronic key is needed by a software player, the extracting module 240 selects a hash function randomly from the plurality of hash functions, and calculates a hash address of each of the plurality of key segments of the electronic key using the selected hash function. For example, the extracting module 240 selects the first hash function to obtain the hash address of the first key segment “7”, the hash address of the second key segment “3”, the hash address of the third key segment “5”, the hash address of the fourth key segment “11”.

In block S307, the extracting module 240 obtains the information of the data storage structure of each of the key segments from the hash table according to the calculated hash address of each of the key segments, extracts the corresponding key segments from the information of the data storage structure, and assembles the extracted key segments to form the key. For example, the extracting module 240 extracts the first key segment from the data storage structure according to the hash address “7”, extracts the second key segment from the data storage structure according to the hash address “3”, extracts the third key segment from the data storage structure according to the hash address “5”, and extracts the fourth key segment from the data storage structure according to the hash address “11”.

Because the key is divided into a plurality of key segments, and each of the key segments is stored in a hash address of a hash table randomly. If the key in needed by a software player, the key protection system 10 extracts each of the key segments from the hash table according to the corresponding hash address, and assembles the extracted key segments to reform the electronic key. Thus, it is difficult to obtain the key illegally using a debug method of the software player.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A method for protecting electronic keys, the method comprising:
setting a plurality of hash functions;
dividing an electronic key into a plurality of key segments, and creating a data storage structure for each of the plurality of key segments, the data storage structure comprising a first bit stream and a second bit stream, the first bit stream comprising one of the plurality of key segments, the second bit stream recording a number of bits of the key segment stored in the first bit stream;
calculating a hash address for each of the plurality of key segments of the electronic key using each of the plurality of hash functions, and obtaining a plurality of hash addresses of the plurality of key segments corresponding to the plurality of hash functions; and
storing information of the data storage structure of each of the plurality of key segments in a hash table according to the hash address of the key segment corresponding to one of the plurality of hash functions.

2. The method according to claim 1, further comprising:
randomly selecting a hash function from the plurality of hash functions upon the condition that the electronic key is needed, and calculating a hash address of each of the plurality of key segments of the electronic key using the selected hash function; and
obtaining the information of the data storage structure of each of the plurality of key segments from the hash table according to the calculated hash address of each of the plurality of key segments, extracting the corresponding key segments from the information of the data storage structure, and assembling the extracted key segments to reform the electronic key.

3. The method according to claim 1, wherein the key is a license key to protect digital data stored in a digital disk.

4. The method according to claim 1, wherein a length of the first bit stream is unchangeable, and the key segment is allocated in the least significant bits of the first bit stream.

5. The method according to claim 1, wherein the data storage structure is an array or a queue.

6. The method according to claim 1, wherein the step of calculating a hash address for each of the plurality of key segments of the electronic key using each of the plurality of hash functions further comprises: resolving a collision of the hash addresses using an open addressing method upon the condition that the collision of the hash addresses occurs.

7. An electronic device, comprising:
a storage device;
at least one processor; and
one or more modules that are stored in the storage device and are executed by the at least one processor, the one or more modules comprising instructions:
to set a plurality of hash functions;
to divide an electronic key into a plurality of key segments, and create a data storage structure for each of the plurality of key segments, the data storage structure comprising a first bit stream and a second bit stream, the first bit stream comprising one of the plurality of key segments, the second bit stream recording a number of bits of the key segment stored in the first bit stream;
to calculate a hash address for each of the plurality of key segments of the electronic key using each of the plurality of hash functions, and obtaining a plurality of hash addresses of the plurality of key segments corresponding to the plurality of hash functions; and
to store information of the data storage structure of each of the plurality of key segments in a hash table according to the hash address of the key segment corresponding to one of the plurality of hash functions.

8. The electronic device according to claim 7, wherein the one or more modules further comprise instructions:
to randomly select a hash function from the plurality of hash functions upon the condition that the electronic key is needed, and calculate a hash address of each of the plurality of key segments of the electronic key using the selected hash function; and
to obtain the information of the data storage structure of each of the plurality of key segments from the hash table according to the calculated hash address of each of the plurality of key segments, extract the corresponding key segments from the information of the data storage structure, and assemble the extracted key segments to reform the electronic key.

9. The electronic device according to claim 7, wherein the key is a license key to protect digital data stored in a digital disk.

10. The electronic device according to claim 7, wherein a length of the first bit stream is unchangeable, and the key segment is allocated in the least significant bits of the first bit stream.

11. The electronic device according to claim 7, wherein the data storage structure is an array or a queue.

12. The electronic device according to claim 7, wherein the instruction to calculate a hash address for each of the plurality of key segments of the electronic key using each of the plurality of hash functions further comprises: resolving a collision of the hash addresses using an open addressing method upon the condition that the collision of the hash addresses occurs.

13. A non-transitory storage medium having stored thereon instructions that, when executed by a processor of an electronic device, causes the processor to perform a method for protecting electronic keys, the method comprising:
setting a plurality of hash functions;
dividing an electronic key into a plurality of key segments, and creating a data storage structure for each of the plurality of key segments, the data storage structure comprising a first bit stream and a second bit stream, the first bit stream comprising one of the plurality of key segments, the second bit stream recording a number of bits of the key segment stored in the first bit stream;
calculating a hash address for each of the plurality of key segments of the electronic key using each of the plurality of hash functions, and obtaining a plurality of hash addresses of the plurality of key segments corresponding to the plurality of hash functions; and
storing information of the data storage structure of each of the plurality of key segments in a hash table according to the hash address of the key segment corresponding to one of the plurality of hash functions.

14. The non-transitory storage medium according to claim 13, wherein the method further comprises:
randomly selecting a hash function from the plurality of hash functions upon the condition that the electronic key is needed, and calculating a hash address of each of the plurality of key segments of the electronic key using the selected hash function; and
obtaining the information of the data storage structure of each of the plurality of key segments from the hash table according to the calculated hash address of each of the plurality of key segments, extracting the corresponding key segments from the information of the data storage structure, and assembling the extracted key segments to reform the electronic key.

15. The non-transitory storage medium according to claim 13, wherein the key is a license key to protect digital data stored in a digital disk.

16. The non-transitory storage medium according to claim 13, wherein a length of the first bit stream is unchangeable, and the key segment is allocated in the least significant bits of the first bit stream.

17. The non-transitory storage medium according to claim 13, wherein the data storage structure is an array or a queue.

18. The non-transitory storage medium according to claim 13, wherein the step of calculating a hash address for each of the plurality of key segments of the electronic key using each of the plurality of hash functions further comprises: resolving a collision of the hash addresses using an open addressing method upon the condition that the collision of the hash addresses occurs.

19. The non-transitory storage medium according to claim 13, wherein the medium is selected from the group consisting of a hard disk drive, a compact disc, a digital video disc, and a tape drive.
